(19) United States
(12) Patent Application Publication
(10) Pub. No.: US 2013/0268327 A1
(43) Pub. Date: Oct. 10, 2013

(54) PROCUREMENT QUALITY IMPROVING SYSTEM

(71) Applicants: Akira Nagamatsu, Yokohama (JP); Kenichi Funaki, Tokyo (JP); Kentaro Taguchi, Hiratsuka (JP); Tetsuro Adachi, Tokyo (JP)

(72) Inventors: Akira Nagamatsu, Yokohama (JP); Kenichi Funaki, Tokyo (JP); Kentaro Taguchi, Hiratsuka (JP); Tetsuro Adachi, Tokyo (JP)

(21) Appl. No.: 13/884,673

(22) PCT Filed: Oct. 12, 2011
(86) PCT No.: PCT/JP2011/073397

§ 371 Date: Jun. 24, 2013

(30) Foreign Application Priority Data
Nov. 12, 2010 (JP) 2010-253411

(51) Int. Cl. G06Q 10/06

(52) U.S. Cl. CPC G06Q 10/06395
USPC 705/7.41

(57) ABSTRACT

Information that specifically points out quality problems in manufacturing processes can be provided to a supplier, thereby providing techniques capable of improving procurement quality. A present procurement quality improving system 1 has a calculating device 11 having a processing function of calculating problems of the manufacturing processes of the supplier and a data storage device 12. The data storage device 12 stores supplier QC process-chart information (D1), process FMEA information (D2) including quality related information, etc. The calculating device 11 has a matching calculating unit 111, which carries out a processing of associating D1 with D2, a first display calculating unit 112, which carries out a processing of presenting the information including quality problem information, etc. calculated by the association to the supplier, etc.

### TECHNICAL FIELD

The present invention relates to techniques of production control (management), EC (electronic commerce), EDI (electronic data exchange), electronic parts procurement, etc., and particularly relates to an information processing system (procurement quality improving system), etc. for improving procurement quality.

### BACKGROUND ART

Examples of conventional techniques related to procurement quality improvement and so forth include Japanese Patent Application Laid-Open No. 2003-6524 (Patent Document 1) (“supplier evaluation system server”, etc.).

Patent Document 1 describes that, “in relation to a supplier evaluation system server, it is an object to automatically evaluate a supplier, to generate and output a screen useful for comprehensive determination, to support stable and effective selection of a purchase source, and to urge the supplier to make an improvement”. Also it is described that the supplier evaluation system server acquires data (electronic commerce data, etc.) from servers (EDI server, etc.), determines evaluation points respectively therefor, summarize the results thereof, generates a screen in accordance with a purpose based on the summarizing result, and transmits that, for example, to a terminal or a supplier system which has sent a request.

(QC Process Chart) A QC process chart is information created for controlling processes, quality, cost, lead time, etc. related to manufacturing of products such as electronic parts. Although depending on a format and so forth, the QC process chart includes information of, for example, products, manufacturing processes (for example, processes and order), equipment (machines), and control items.

(Process FMEA) Process FMEA (Process Failure Mode and Effects Analysis) is a type of FMEA (an FMEA focusing on process elements) and is a method of predicting and extracting problems (problems in processes, causes and mechanisms of failure occurrence, etc.) in advance by analyzing effects exerted on products by phenomena such as defects, variations, etc. occurring due to flaws/problems in processes. The process FMEA focuses on elements such as processes, humans, materials, equipment (machines), etc. in the environment for manufacturing the products and extracts failure modes, failure causes, etc. For example, human errors in the processes that require operations by humans are taken into consideration. The process FMEA uses information necessary for understanding manufacturing processes such as QC process charts.

### PRIOR ART DOCUMENT

### Patent Document

Patent Document 1: Japanese Patent Application Laid-Open Publication No. 2003-6524

### DISCLOSURE OF THE INVENTION

### Problems to be Solved by the Invention

Above-described Patent Document 1 describes a method of evaluating counterparties (procurement sources, suppliers) from viewpoints of quality, delivery date, etc. and urging an improvement if there is a problem(s).

However, in the improving method like that of Patent Document 1 for example, in which process a quality problem is expected to occur cannot be evaluated (such a function is not provided). Therefore, for example, which part or point (for example, which individual process) in the entire manufacturing processes (process flow) has a problem cannot be extracted or pointed out. More specifically, since a precise point-out or information presentation etc. cannot be provided to the counterparty (supplier) etc., procurement quality cannot be improved. Also, even in a case in which the counterparty (supplier) starts making an effort for quality enhancement/improvement (for example, re-examination of manufacturing processes), for example, from which point (for example, process) the problem should be solved is unknown; therefore, it is conceivable that progress is not made in procurement quality improvement as a result.

In view of the foregoing, it is a main preferred aim of the present invention to provide techniques by which information specifically pointing out quality problems in manufacturing processes (for example, in which points problems exist) can be provided to, for example, a supplier in relation to, for example, a procurement-product improving system, and the quality of procurement products (for example, parts produced by the supplier) can be therefore enhanced/improved.

### Means for Solving the Problems

To achieve the above-described preferred aims, a typical embodiment of the present invention is a procurement product improving system that carries out information processing related to improvement or control of quality of a procurement product and has a feature in having a configuration descried below.

The present procurement quality improving system includes a calculating device having a processing function of calculating problems (for example, key-point processes) in manufacturing processes (process flow) of the supplier and a data storage device that stores data information used in the calculation. The data storage device stores first information including information related to the manufacturing processes such as a QC process chart of the supplier and second information including quality-related information according to, for example, process FMEA. The calculating device includes a matching calculating unit that carries out a processing of association of the first information with the second information of the supplier and a first display calculating unit that carries out a processing of presenting (for example, screen display), to the supplier, information including the first information, information of a key-point process related to a quality problem in the manufacturing processes of the supplier, the information of the process calculated by the association, and information of the quality problem such as a corresponding failure mode and a failure cause according to the process FMEA.

### Effects of the Invention

According to the typical embodiment of the present invention, the information for specifically pointing out quality problems in the manufacturing processes can be presented to the supplier, and quality of procurement products can be enhanced/improved as a result.

### BRIEF DESCRIPTIONS OF THE DRAWINGS

FIG. 1 is a diagram illustrating a configuration example of a system (procurement quality improving system) of a first embodiment of the present invention;

FIG. 2 is a diagram illustrating a detailed configuration example of the system of the first embodiment;

FIG. 3 is a diagram illustrating an example of a processing flow (example of a processing sequence between a buyer and a supplier) of the system of the first embodiment;

FIG. 4 is a diagram illustrating an example of a table (T1) of a supplier QC process-chart information (D1);

FIG. 5 is a diagram illustrating an example of a table (T2) of process FMEA information (D2);

FIG. 6 is a diagram illustrating an example of a table (T3) of thesaurus information (D3);

FIG. 7 is a diagram illustrating an example of a table (T4) of supplier quality-level information (D4);

FIG. 8 is a diagram illustrating an example of a table (T6) of supplier QC process-chart revised information (D6);

FIG. 9 is a diagram illustrating a flow example of a matching processing in the system of the first embodiment;

FIG. 10 is a diagram illustrating an example of a QC process-chart input screen (G0) according to the supplier;

FIG. 11 is a diagram illustrating an example of a QC process-chart revised information input screen (G1) according to the supplier;

FIG. 12 is a diagram illustrating an example of a screen (G2) of process FMEA check status information (supplier QC process-chart control) according to the supplier;

FIG. 13 is a diagram illustrating an example of transaction relations between a buyer and suppliers, manufacturing processes, matching, etc.;

FIG. 14 is a diagram illustrating a configuration example of a system used in electronic commerce of parts procurement as a system (procurement quality improving system) of a second embodiment of the present invention;

FIG. 15 is a diagram illustrating an example of a processing flow in the system of the second embodiment;

FIG. 16 is a diagram illustrating an example of a table (T21) of information of requested order-accepting prices of order-accepting candidate companies (suppliers); and

FIG. 17 is a diagram illustrating an example of a screen (G21) of determination of the order-accepting company (supplier) according to an order placer (buyer).

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

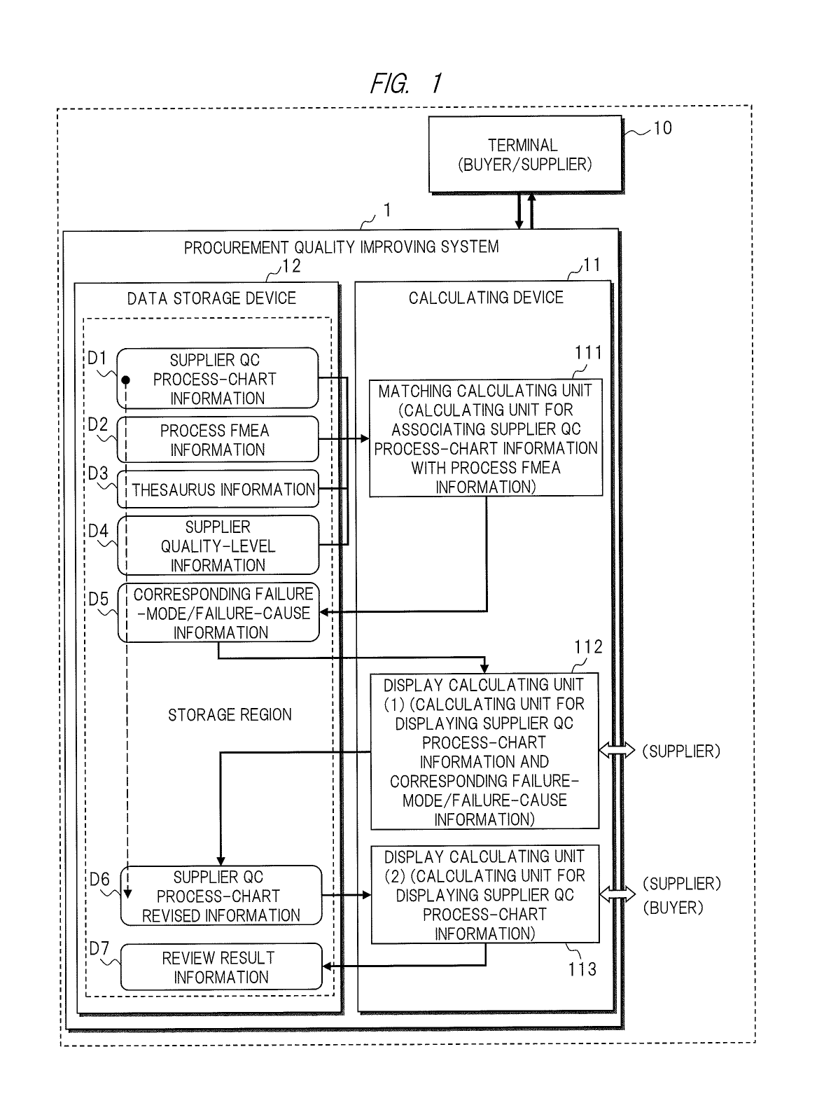

It is a preferred aim of a system (FIG. 1, etc.) of a present embodiment to improve the quality of procurement products, for example, in a business relationship between a buyer and a supplier. For the purpose of that, the present system has a processing function of calculating information, with which a key point related to quality problems in manufacturing processes of the supplier can be specifically pointed out to urge an improvement, and of presenting the information to the supplier. The present system uses QC process-chart information (D1) of the supplier, process FMEA information (D2), and other information (D3, D4) to carry out association (matching) between QC process chart information (D1) and process FMEA information (D2) while using, for example, processes as keys and present (screen display) information (D5) of corresponding failure mode, failure causes, etc., which are expected to occur, to the supplier.

### First Embodiment

A procurement quality improving system of the first embodiment of the present invention will be explained with reference to FIG. 1 to FIG. 13. In the first embodiment, the procurement quality improving system utilizes the information of a QC process chart input by a supplier, and the relation between a buyer and the supplier is on a one-to-one basis.

[System]

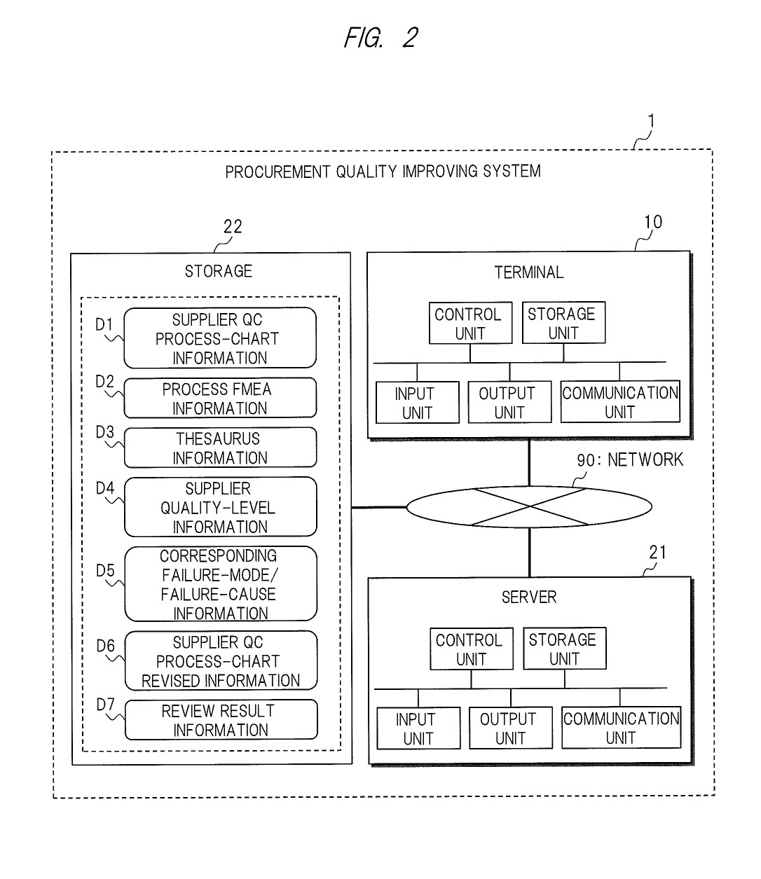

FIG. 1 and FIG. 2 illustrate configuration examples of the procurement quality improving system according to the first embodiment. The procurement quality improving system 1 (procurement quality improving device) of FIG. 1 has a configuration in which a calculating device 11 and a data storage device 12 are connected to each other and is connected to a terminal 10 (operator input/output device) of a user (buyer or supplier). Hereinafter, it will be also simply referred to as the system 1. The present system 1 provides at least a processing function (the processing function of calculating the information for pointing out quality problems of manufacturing processes of the supplier) for procurement quality improvement. The processing function of the present system 1 is achieved by the calculating device 11 and the data storage device 12 and can be utilized by the user from the terminal 10. Note that the present system 1 may be configured to be linked with or integrated with, for example, an existing part procuring system.

As a detailed configuration of the system 1 of FIG. 1, FIG. 2 illustrates a configuration example of an information processing system interconnected between computers on a network 90 such as the Internet or a LAN. The terminal 10, a server 21 (corresponding to the calculating device 11 of FIG. 1), a storage 22 (corresponding to the data storage device 12 of FIG. 1), etc. are connected to the network 90. In the server 21, processing units (functions) such as a matching calculating unit 111 in the calculating device 11 of FIG. 1 are achieved by, for example, executing programs of a storage unit(s) (for example, a memory or a disk) by a control unit (for example, a processor). The storage 22 is, for example, a storage or a database server connected to the network 90 or the server 21 and stores various data information (D1 to D7) in a storage region.

The terminal 10 is a computer such as a PC used by the user (the buyer, the supplier, or someone else concerned) of the present system 1, and input/output, etc. of instructions and data information with respect to the present system 1 are carried out thereat. For example, in the terminal 10 of FIG. 2, a function such as that of a Web browser is achieved by executing a program of the storage unit (for example, a memory or a disk) by the control unit (for example, a processor). A communication unit of the terminal 10 carries out, for example, interface processing with respect to the network 90. In the terminal 10, based on user operations, for example, input of necessary instructions or data information or result-information display is carried out by, for example, a Web-browser screen through the input unit (for example, a keyboard) and an output unit (for example, a display). In accordance with, for example, the input of instructions, the terminal 10 (communication unit) accesses the server 21 via the network 90, and the server 21 carries out a processing corresponding to the instructions etc. by using the data information of the storage 22 and returns a result to the terminal 10.

The calculating unit 11 includes processing units such as: a matching calculating unit 111 (a calculating unit for associating the supplier QC process-chart information with the process FMEA information), a first display calculating unit 112 (a calculating unit for displaying the supplier QC process-chart information and corresponding failure-mode/failure-cause information), and a second display calculating unit 113 (a calculating unit for displaying the supplier QC process-chart information).

The data storage device 12 stores, as the data information, the supplier QC process-chart information D1, the process FMEA information D2, thesaurus information D3, supplier quality-level information D4, corresponding failure-mode/failure-cause information D5, supplier QC process-chart revised information D6, review result information D7, etc. in the storage region.

When the present processing function is to be utilized by the user, the matching calculating unit 111 carries out a processing of association (matching) of the supplier QC process-chart information D1 with the process FMEA information D2 (for the manufacturing processes of the same supplier) using output of the data (D1 to D4) stored in the data storage device 12, thereby calculating the information (D5) of the corresponding failure-mode/failure-cause (the information of quality problems based on the process FMEA). The result of the calculation is stored in the data storage device 112 as the corresponding failure-mode/failure-cause information D5.

The first display calculating unit 112 carries out a processing for presenting/showing information such as the supplier QC process-chart information D1 and the corresponding failure-mode/failure-cause information D5 to the supplier in the form of, for example, Web screen display. Note that the same information (for example, the screen) can be referenced not only by the supplier but also, for example, the buyer similarly by accessing from the terminal 10.

In addition, the first display calculating unit 112 creates the supplier QC process-chart revised information D6 based on the data information (revised (modified) information of D1) input by the supplier referencing the above-described presented information (D5, etc.) and stores the information D6 in the data storage device 12. The information is presented to, for example, the supplier.

In addition, the second display calculating unit 113 carries out a processing of presenting/showing information to the supplier (or the buyer including, for example, the above-described supplier QC process-chart revised information D6 and the corresponding failure-mode/failure-cause information D5). The second display calculating unit 113 presents not only D1 or D6 but also the corresponding failure-mode/failure-cause information D5 (information according to process FMEA) in combination to the supplier. By virtue of this, the supplier is capable of recognizing processes, etc. which are key points related to quality problems. The second display calculating unit 113 presents information (check status), for example, that whether the contents of the above-described presented information (information according to the process FMEA) have been checked or not to the supplier (or the buyer) and stores that information in the data storage device 12 as the review result information D7.

[Data Information]

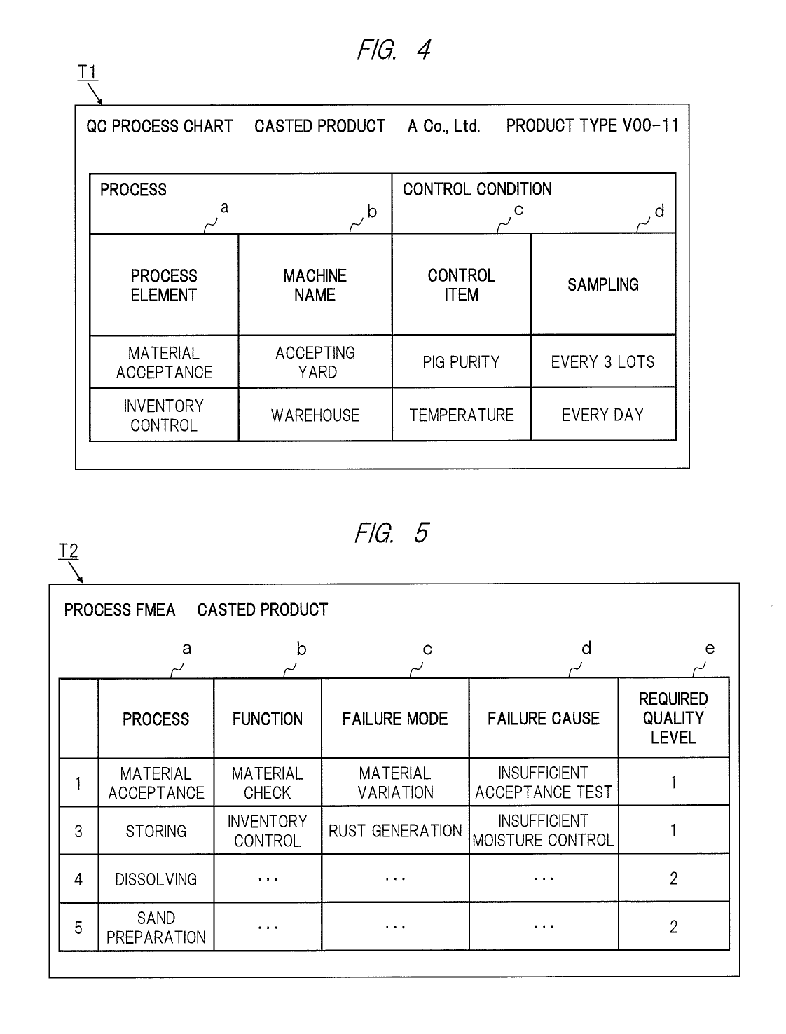

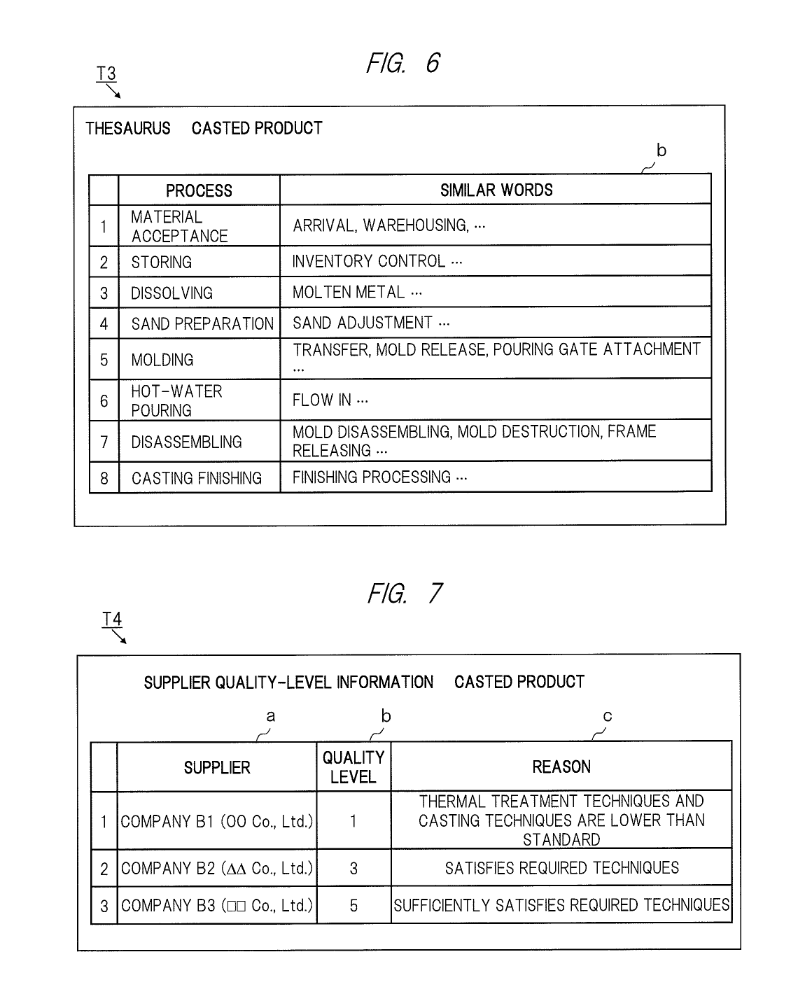

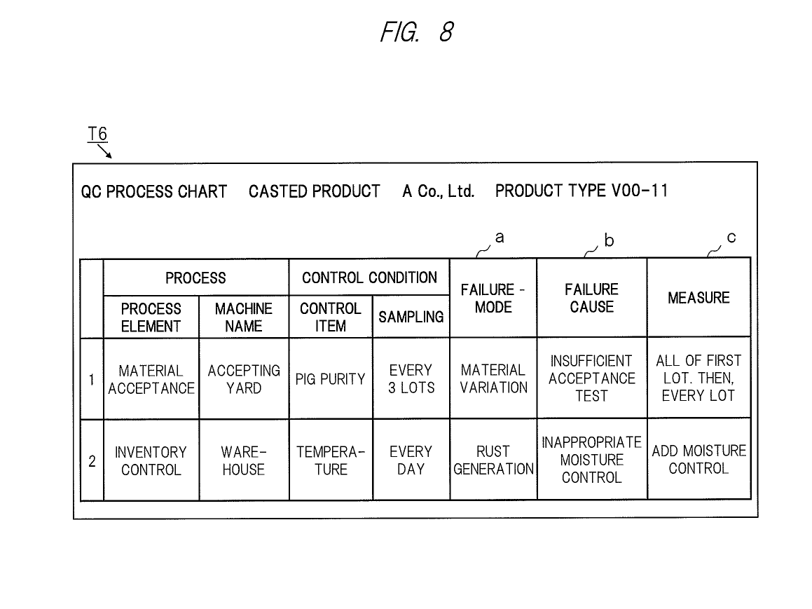

FIG. 4 to FIG. 8 show tables of data structure examples of the various data information (D1 to D4, D6). FIG. 4 illustrates the supplier QC process-chart information D1 (table T1), FIG. 5 illustrates the process FMEA information D2 (table T2), FIG. 6 illustrates the thesaurus information D3 (table T3), FIG. 7 illustrates the supplier quality-level information D4 (table T4), FIG. 8 illustrates the supplier QC process-chart revised information D6 (table T6). An example of D5 will be shown by a screen (G1) described below. An example of D7 will be shown by an example of a screen (G2) described below.

[D1: Supplier QC Process-Chart Information]

FIG. 4 illustrates the table T1 of the supplier QC process-chart information D1. D1 is the information (at least including information of processes and the order thereof) of a QC process chart of the supplier inputted (or, for example, provided) by the supplier. D1 includes information of each supplier. T1 is created in the present system 1 by information inputted in a screen (G0). T1 of FIG. 4 includes information of processes ((a) process elements, (b) machine names), information of control conditions ((c) control items, (d) sampling), etc.

[D2: Process FMEA Information]

FIG. 5 illustrates the table T2 of the process FMEA information D2. D2 is the information of the process FMEA related to an order placer which is, for example, inputted and stored in advance by the order placer (buyer). Since the process FMEA itself is a publicly-known technique, detailed explanation thereof will be omitted. D2 includes at least the information of process elements and quality problems (for example, failure mode, failure cause) related to manufacturing processes (process flow) of the supplier. D2 includes the information of each supplier.

T2 of FIG. 5 contains the information items of, for example, (a) process, (b) function, (c) failure mode, (d) failure cause, and (e) required quality level. In the example of FIG. 5, when the process of “a” is “material acceptance”, the function of “b” is material-type check, material variation is present as the failure mode of “c”, an insufficient acceptance inspection is present as the failure cause of “d”, and the required quality level of “e” is 1.

[D3: Thesaurus Information]

FIG. 6 illustrates the table T3 of the thesaurus information D3 (related to the “process” information of the process FMEA information D2). D3 is, for example, thesaurus information (synonym dictionary) stored in advance. D3 may be, for example, configured to be utilized by access to a service of thesaurus information on the Internet. D3 includes thesaurus information related to elements such as the processes used as keys in the matching processing. T3 of FIG. 6 includes the information of, for example, (a) process and (b) synonyms. For example, the synonyms related to “material acceptance” includes “arrival”, “warehousing”, etc.

[D4: Supplier Quality-Level Information]

FIG. 7 illustrates the table T4 of the supplier quality-level information D4. D4 is, for example, the quality level information of the products which can be manufactured by the supplier, in which the information is evaluated/input and stored in advance by buyer. T4 of FIG. 7 includes information items of, for example, (a) the supplier, (b) quality level, and (c) reason. For example, as companies of the suppliers of a, B1, B2, and B3 are provided, and the quality levels of “b” are 1, 3, and 5. As the reasons of c, the reasons of the levels of b are described. Existing methods can be applied for the evaluation or definition of, for example, the quality levels related to D4.

[D5: Corresponding Failure-Mode/Failure-Cause Information]

The corresponding failure-mode/failure-cause information D5 is stored as a processing result of the matching calculating unit 111 and is used as an input in the processing of the first display calculating unit 112. D5 is the information which is, for example, the failure-modes/failure causes obtained based on the process FMEA (process FMEA information D2) and related to quality problems of manufacturing processes of the supplier.

[D6: Supplier QC Process-Chart Revised Information]

FIG. 8 illustrates the table T6 of the supplier QC process-chart revised information D6. D6 is the information of a modified version (after update) of D1, and the information of a QC process chart (modified version) created by the supplier in consideration of the information (D5) according to the corresponding process FMEA is stored. D6 is stored as a processing result of the first display calculating unit 112 and used as an input at the second display calculating unit 113. T6 contains the information similar to that shown in the screen (G1) of FIG. 11.

[D7: Review Result Information]

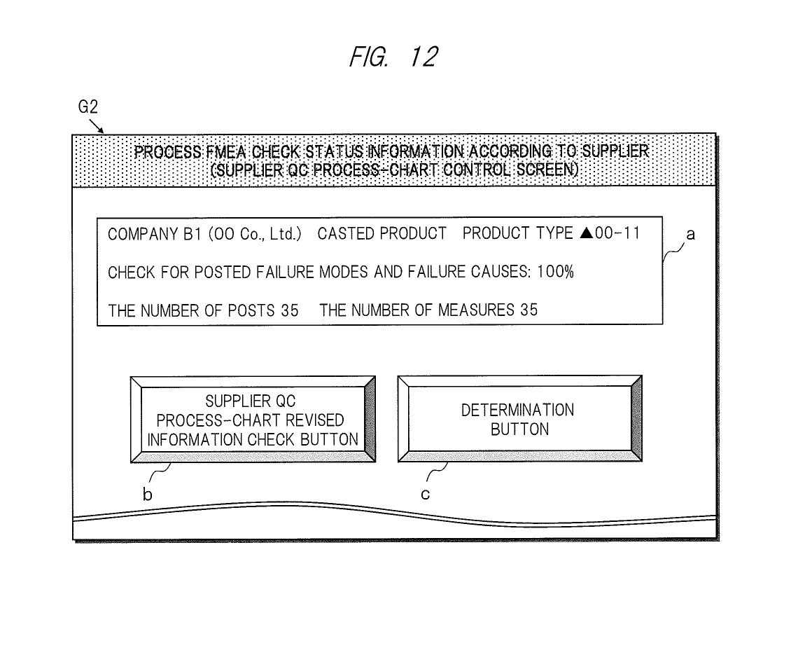

The review result information D7 is stored as a processing result of the second display calculating unit 113. D7 includes the information similar to that shown in the screen (G2) of FIG. 12.

[Processing Outline]

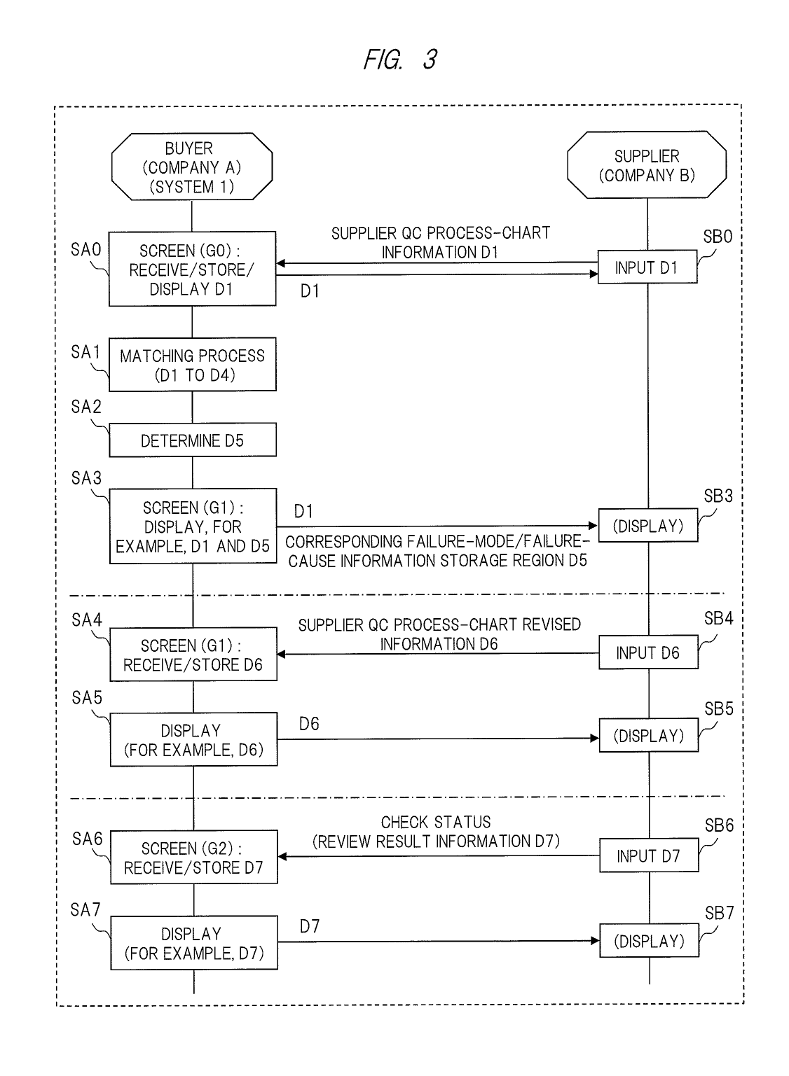

FIG. 3 illustrates an example of a processing flow in the present procurement quality improving system 1. The processing flow of the present system 1 is illustrated mainly on the left side (SA0 to SA7) (also corresponding to FIG. 1). SA0, SB0, etc. represent processing steps. FIG. 3 illustrates the processing sequence between the buyer (A) and the supplier (B) in a case in which the buyer (for example, company A) on the left side mainly provides/utilizes the present system 1 and the supplier (for example, company B) on the right side accesses the buyer or the present system 1 on the left side to utilize a processing function (for example, a service or a screen) of the system 1. If the present system 1 is independent from the buyer and formed on, for example, the network 90, both of the buyer and the supplier are configured to access the present system 1 (for example, the server 21 of FIG. 2) from the terminal 10 via the network 90 to utilize the service.

The processing outline of FIG. 3 is as described below (details will be described later). The buyer (A), the supplier (B), etc. referred to hereinafter correspond to users, the terminals 10 of the users, etc. It is configured to make access appropriately from the supplier (B) to a Web screen based on the Web; however, it is not limited to the Web, but may use, for example a configuration in which data is sent to the supplier (B) and referenced thereat.

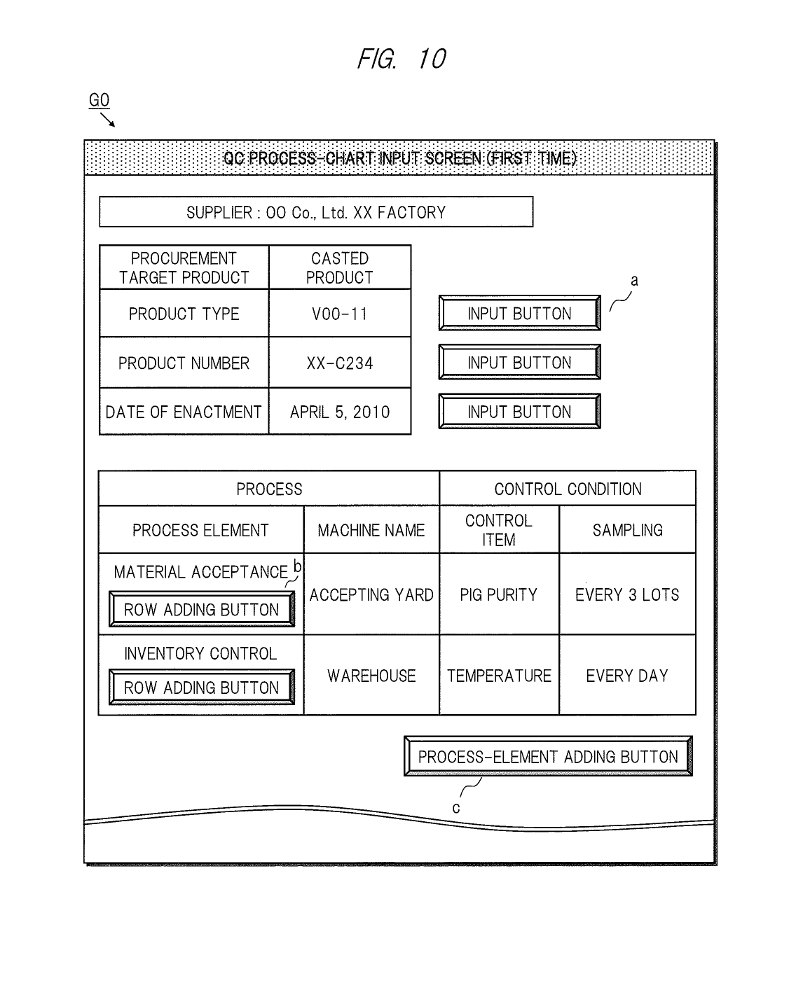

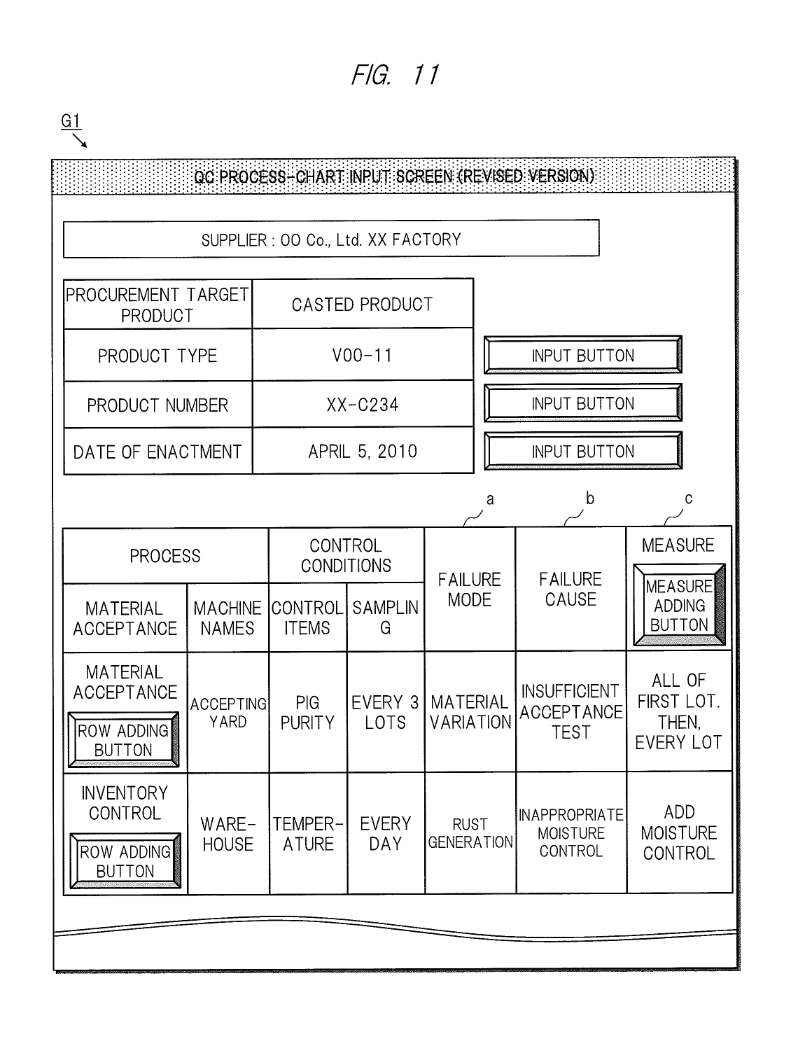

(SA0, SB0) In SA0, input of the supplier QC process-chart information D1 from the supplier (B) is accepted (SB0) with respect to the screen (described later, FIG. 10, G0) provided by the present system 1 or the buyer (A), the input information (D1) is stored in the table (T1), and the input information is displayed on the screen.

(SA1) In SA1, the matching calculating unit 111 carries out a matching processing using the data information of above-described D1 and D2 to D4 (in the data storage device 12). More specifically, a processing of associating the above-described input supplier QC process-chart information D1 with the process FMEA information D2 using the thesaurus information D3 and the supplier quality-level information D4.

(SA2) In SA2, the matching calculating unit 111 determines (computes) the corresponding failure-mode/failure-cause information D5 by the above-described matching processing and stores the information in the data storage device 12.

(SA3, SB3) In SA3, the first display calculating unit 112 carries out a processing of displaying the information of, for example, D1 and D5 on the screen (described later, FIG. 11, G1) using above-described D5. The supplier (B) can view the information by the screen and recognize/confirm the contents thereof (SB3). The information like D5 (information according to process FMEA) can be presented to the supplier in combination with the information like D1. Thus, the supplier can be urged to make an improvement about manufacturing processes by specifically pointing out key points (for example, processes) relates to quality problems.

(SA4, SB4) Then, in SA4, the supplier (B) carries out, for example, re-examination of the manufacturing processes (corresponding QC process chart) referencing the presented information such as above-described D1 and D5 and inputs the supplier QC process-chart revised information D6 (modified-version information of D1) by the screen (G1) provided by the second display calculating unit 113 (SB4). When input of D6 by the screen (G1) is received, the second display calculating unit 113 stores the input information (D6) in the table (T6).

(SA5, SB5) In SA5, the second display calculating unit 113 displays the information of above-described D6 on the screen (G1). The supplier (B) can view the information by the screen (G1) and check the contents thereof (SB5). The buyer (A) can also view the information.

(SA6, SB6) Further thereafter, in SA6, based on viewing of the information such as above-described D6, the supplier (B) inputs the information of a check status(es) (information representing, for example, how much confirmations and measures have been carried out) corresponding to, for example, the information according to the process FMEA (for example, the presented corresponding failure-modes/failure causes) with respect to the screen (described later, FIG. 12, G2) provided by the second display calculating unit 113 (SB6). The input information is stored in the data storage device 12 as the review result information D7 by a processing of the second display calculating unit 113.

(SA7, SB7) Also after that, the buyer (A) and the supplier (B) can view and check the review result information D7 by the screen (G2) (SB7). The second display calculating unit 113 displays the information of above-described D7 on the screen (G2).

Between above-described SB3 and SB4 and between SB5 and SB6, there is time for, for example, problem recognition or improvement consideration by the user (supplier).

[Transaction Relation, Etc.]

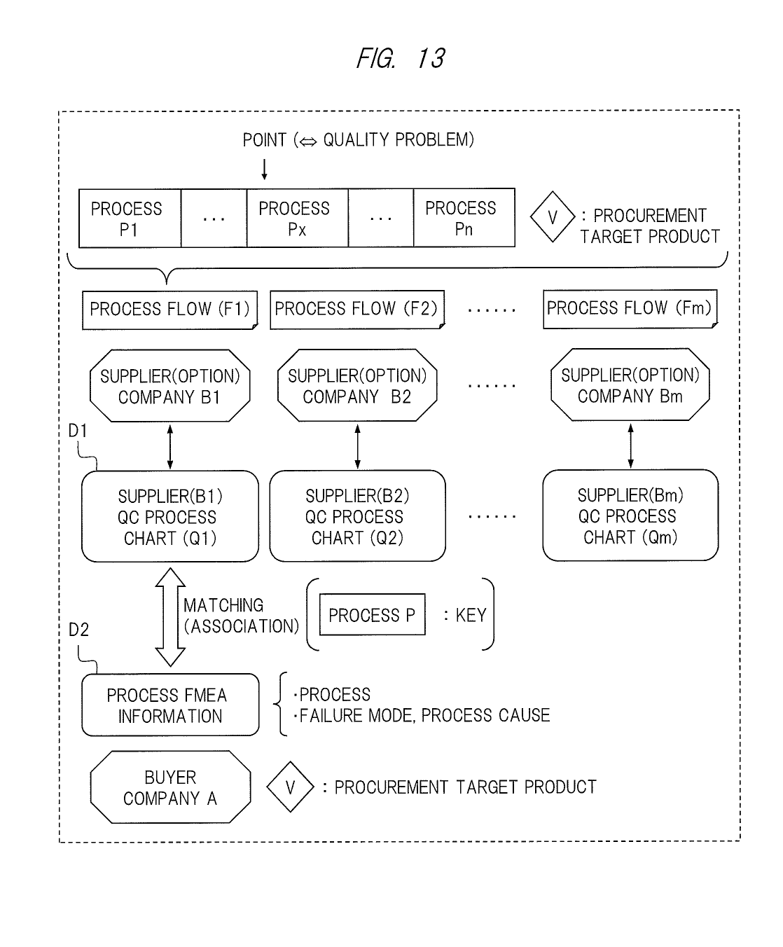

FIG. 13 illustrates an example of transaction relations between a buyer and suppliers, manufacturing processes, matching, etc. in order to supplement explanation. This is a case of one-to-many transactions. With respect to the buyer (for example, company A), a plurality (m) of suppliers (for example, company B1 to company Bm), which are, for example, candidates of counterparties (suppliers) related to procurement target products (V), are provided. The suppliers (B) are, for example, factories/companies which manufacture and sell parts and materials. Each of the suppliers (B) has manufacturing processes (process flow (referred to as F)) related to the procurement target products (V) and has a corresponding QC process chart (referred to as Q). Each of the process flows (F: F1 to Fm) includes a plurality (n) of processes like a process P1 to a process Pn (details differ depending on the companies), and information of, for example, the order and machines thereof is described in the QC process chart (Q: Q1 to Qm).

For each supplier (B), the buyer (A) carries out a matching processing with respect to the information (D1) of the QC process chart (Q) of the supplier (B) by using the information (D2) of the corresponding process FMEA while using, for example, a process P as a key. Thus, the information (D5) of, for example, a point(s) (for example, the process P) in the process flow (F) having a problem(s) (quality problem) and the corresponding failure-modes/failure-causes related to the point (quality problem) is pointed out or presented to the supplier (B).

### [Processing Details]

Based on the above-described configuration, hereinafter, an example of processing details of the present system 1 will be explained also with reference to screen examples (FIG. 10 to FIG. 12), etc.

First, in SA0 and SB0, the present system 1 provides the screen (G0) as illustrated in FIG. 10 to the terminal 10 of the user, and the information (D1) of the supplier QC process chart is inputted from the supplier (B).

[Screen (G0)]

FIG. 10 illustrates the supplier QC process-chart input screen (G0) at a point when the supplier is to input the information (D1) of the QC process chart. The present screen (G0) is a screen example of a first screen (a case of a first-time input of D1). In the present screen (G0), as illustrated in the drawing, the information of the supplier (for example, a company name and a factory name), the information of the procurement target product (for example, a product type, a product number, and the date of enactment), the information of processes (for example, process elements and machine names), the information of control conditions (for example, control items and sampling), etc. are input/displayed.

For example, the product type of procurement (the product type of the procurement target product), the product number, the date of enactment, etc. can be input, for example, by input buttons of “a”. The information related to processes can be added by, for example, a row adding button of “b” or a process-element adding button of “c”. In the example of FIG. 10, examples of the processes of the supplier include “material acceptance” and “inventory control”.

When the information is input via the screen (G0), the table T1 of D1 as shown in FIG. 4 is created and stored.

[Matching Processing]

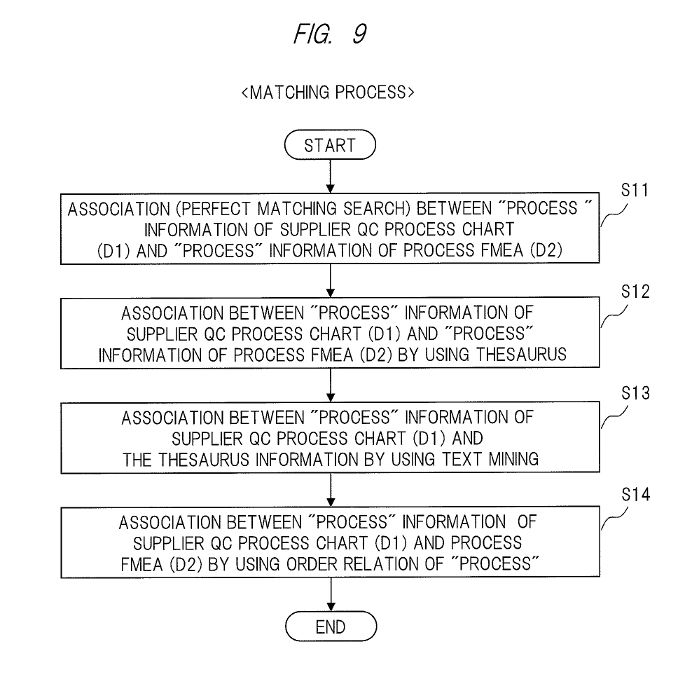

Then, in above-described SA1, the matching processing shown in FIG. 9 by the matching calculating unit 111 is carried out. In this process, in addition to D1 and D2, D3 and D4 are used to mutually associate the information of, for example, processes.

(S11) First, in S11 of FIG. 9, association by exact search using a process(s) as a key is carried out. More specifically, exact search is carried out for the words (character strings) described in the parts of the column of the “processes” of “a” in the table T2 of the process FMEA information D2 of FIG. 5 stored in advance and the column of “process elements” of “a” in the table T1 of the supplier QC process-chart information D1 of FIG. 4. In this process, with respect to the corresponding (matching) one(s), the information of the “failure mode” of “c” and the “failure cause” of “d” of T2 is allocated to the “process element” of “a” in T1. For example, since “material acceptance” is mutually corresponding (matching) in T1 and T2, “material variation” of the “failure mode” of “c” and “insufficient acceptance inspection” of the “failure cause” of “d” are allocated to the process.

(S12) Then, in S12, association by the search using the thesaurus information D3 is carried out. More specifically, the one(s) (word(s)) not allocated in S11 is subjected to exact search between the “similar words” of “b” in the table T3 of the thesaurus information D3 of FIG. 6 related to the “process” of “a” (for example, “material acceptance”) in the process FMEA information D2 of T2 of FIG. 5 and the “process element” of “a” in T1 of FIG. 4. As a result, regarding the corresponding one, the information of the “failure mode” of “c” and the information of the “failure cause” of “d” is allocated to the “process element” of “a” in T1.

(S13) Then, in S13, the one(s) (word(s)) not allocated in S12 is subjected to association by a processing using a text mining method (for example, morphological analysis and cluster analysis) (publicly known techniques). First, the words are decomposed to minimum meaningful units of words such as single words and word classes by morphological analysis which is one type of natural language processing.

The “process elements” of “a” in T1 of FIG. 4 and the “similar words” of “b” in T3 of FIG. 6 are decomposed by using the morphological analysis. For example, in the case of the “process elements” of “a” in T1, “material acceptance” can be decomposed into “material” and “acceptance”. “arrival” and “warehousing” of the “similar words” of “b” in T3 have already been minimum units and are thus not changed.

Then, the number of matching morphemes among the above-described “process elements” and “similar words” is counted, the distance(s) of thereof is calculated, and cluster analysis of determining similarity depending on the closeness of the distance is carried out. As a specific example of morpheme counting, each of “material” and “acceptance” is counted as one in process of “material acceptance” in T1. The gatherings of morphemes of the “process elements” of FIG. 4 and the “similar words” of FIG. 6 are referred to as clusters.

As a calculating formula of the distance, a squared Euclidean distance, which is a typical example, is shown as the following Expression (1). The calculating method for the distance can be selected by the user. Notations represent D: distance, l: number of variables, x: variable, and i, j: sample names, respectively.

$$\begin{matrix}[ Mathematical Expression 1 ] & \\ {D}_{ij} = {\sum }_{k = 1}^{l} {( {x}_{ki} - {x}_{kj} )}^{2} & Expression ( 1 )\end{matrix}$$

As a criterion of the similarity according to the closeness of the above-described cluster distance, for example, a dendrogram is created, and selection is made by the user.

As the calculating formula of the distance between the clusters in creation of the above-described dendrogram, the nearest neighbor method which is a typical calculation example is shown as the following Expression (2). Notations represent D: distance and a, b, c, f: clusters (c is an integrated cluster of a and b, and an arbitrary cluster is f).

[Mathematical Expression 2]

D_{cf}=min(D_{af},D_{bf}) Expression (2)

In the above-described procedure, the supplier QC process chart (D1) and the process FMEA (D2) are associated by the morphological analysis and cluster analysis.

(S14) Then, in S14, the one(s) (word(s)) not allocated in S13 is allocated to the “process element” of “a” in T1 of FIG. 4 in consideration of the anteroposterior relation (order) in the plurality of processes of the “process” of “a” in T2 of FIG. 5. For example, in the “process” of “a” in T2, “storing” is present between “material acceptance” and “dissolving”; and, if no corresponding one is present between “material acceptance” and “dissolving” in T1 until S13, “storing” is allocated thereto.

Through the above procedure, the matching processing (SA1) of the supplier QC process chart (D1) and the process FMEA (D2) using D1 to D4 is carried out.

Subsequently, in above-described SA2, in accordance with a level by which quality of the supplier can be maintained, a processing for presenting the information (D5) of failure modes and failure causes included in the process FMEA information D2 of FIG. 5 is carried out.

In that process, the information of “quality levels” of “b” in the table T4 of the supplier quality-level information D4 of FIG. 7 and “required quality levels” of “e” in T2 of FIG. 5 are used as keys to display corresponding ones. For example, examples of the processes for which the quality level “b” of the company B1 in T4 is 1 and the “required quality level” of “e” in T2 is 1 include “material acceptance”.

### [Screen (G1)]

FIG. 11 illustrates an example of the supplier QC process-chart revised information input screen (G1) of at a point when the information (D6) of the QC process chart (modified version) is to be input by the supplier in consideration of the information of the corresponding process FMEA. In the present screen (G1), with respect to the first-time screen (G0), the items of (a) failure mode, (b) failure cause, and (c) measure are added. In above-described SA3, in consideration of the results obtained until SA2, information is displayed in the items of (a) failure mode and (b) failure cause in the screen (G1) of FIG. 11. The user of the supplier inputs the information of measures by pressing a measure adding button of the measure “c” in consideration of the presented information such as “a” and “b” of FIG. 11.

Then, in above-described SA4 etc., a processing of storing the information, which has been input by the screen (G1), in the table T6 of the supplier QC process-chart revised information D6.

[Screen (G2)]

FIG. 12 illustrates the screen (G2) of the process FMEA check status according to the supplier. In above-described SA6 etc., the screen (G2) of FIG. 12 is presented to the user of the buyer (for example, company A). The present screen (G2) is a screen example for this organization to control the supplier QC process chart, etc. and shows status information that, for example, whether the supplier has checked the information according to the process FMEA (for example, the corresponding failure modes and failure causes). “a” is quantitative information presented to the user of the buyer (A) in order to do that and is computed and displayed based on the information of the (a) failure mode and the (c) measure in T6 of FIG. 8. For example, “a” denotes the degree (%) of checks by the supplier about the posted failure modes and failure causes, the number of posts, the number of measures, etc. The user of the buyer (A) can display and check the contents in T6 of FIG. 8 on the screen (FIG. 11) by pressing a supplier QC process-chart revised information check button of “b”. When a determination button of “c” is pressed in the end, the processing is terminated.

### Second Embodiment

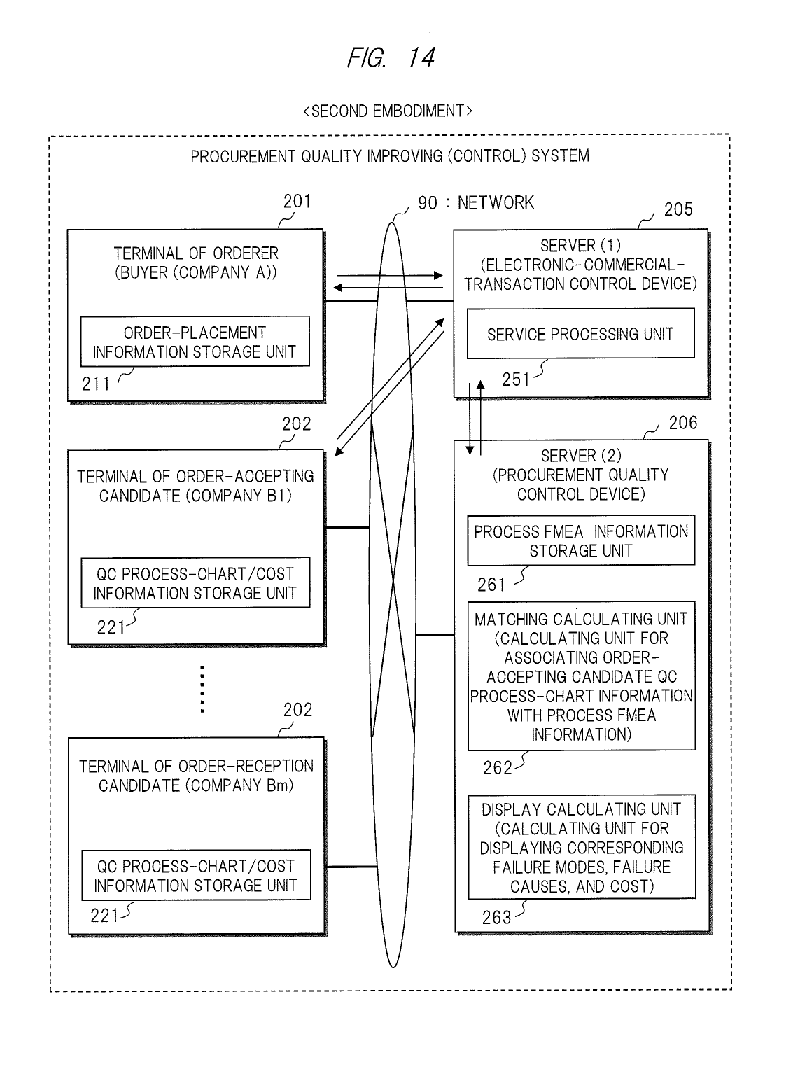

Next, a second embodiment will be described with reference to FIG. 14 to FIG. 17, etc. A system (procurement quality improvement control of an electronic commerce type) of the second embodiment is a mode in which the system 1 of the first embodiment is utilized in electronic commerce of parts procurement; in the illustrated example, terminals, servers, etc. are configured to be connected on the network 90, and a buyer (order placer) enables a transaction of determining a supplier (order acceptor) as a service. In the second embodiment, basically, a second server 206, etc. of FIG. 14 are provided to contain the processing functions described in the first embodiment (for example, presenting information of quality problems to suppliers). Furthermore, the second embodiment is configured to provide order-placing/order-accepting services (auction style) of electronic commerce of procurement by using a first server 205, etc. of FIG. 14. A buyer (A) can, for example, select a supplier, from which procurement products are to be actually purchased, from a plurality of options of suppliers (B) in consideration of, for example, procurement quality and requested order-accepting price. One-to-many or many-to-many can be similarly applied to the transaction relation between the buyer (A) and the suppliers (B). The present embodiment describes a case in which one buyer (company A) determines one supplier from a plurality of options of suppliers (B1 to Bm) as an order acceptor (supplier).

FIG. 14 illustrates a configuration example of the system of the second embodiment. The present system is configured to include: one or more terminal(s) 201 of an orderer(s) (buyer(s) (company A)); a plurality (m) of terminals 202 {terminal of company B1, . . . , terminal of company Bm} of order-accepting candidates (suppliers); the first server 205 (electronic-commercial-transaction control device); and the second server 206 (procurement-quality control device), which are connected to the network 90 (for example, the Internet). Although not illustrated in the drawing, data information may be similarly controlled in the storage 22 as illustrated in FIG. 2.

Each of the terminals (201, etc.) is a device provided with a processing function of carrying out electronic commerce of parts procurement and is, for example, a PC provided with a Web browser, etc. The terminal 201 of the company A side, for example, places an order about parts procurement to the first server 205. The terminal 202 of the company B side, for example, sends an order-accepting request about parts procurement to the first server 205. The terminal 201 of the company Aside has an order-placement information storage unit 211. The order-placement information storage unit 211 stores order-placement information according to the orderer (company A). The terminal 202 of the company B side has a QC process-chart/cost information storage unit 221. The QC process-chart/cost information storage unit 221 stores QC process-chart/cost information (for example, price) according to the order-accepting candidate (company B).

The first server 205 is a device using, for example, a Web server provided with a control function of electronic commerce of parts procurement and has a service processing unit 251, which provides services to access from the terminals (201, etc.).

The second server 206 is a procurement-quality control device provided with processing functions for improving/controlling parts procurement quality (including the processing functions provided by the system 1 of the first embodiment) and carries out processing linked with the first server 205. In response to a request from the first server 205, the second server 206 carries out processing and returns a result to the first server 205.

The second server 206 has a process FMEA information storage unit 261, a matching calculating unit 262 (a calculating unit for associating order-accepting-candidate QC process-chart information with process FMEA information), and a display calculating unit 263 (a calculating unit for displaying corresponding failure modes, failure causes, and cost).

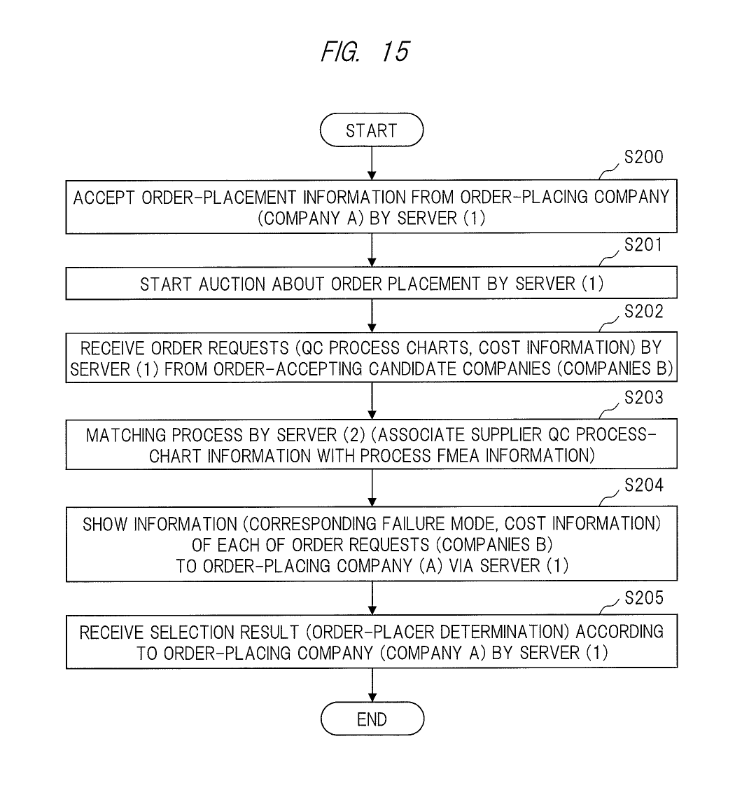

FIG. 15 illustrates an example of a processing flow in the second embodiment.

(S200) In S200, the first server 205 (service processing unit 251) receives order-placement information (based on 211) such as drawings/specifications related to a procurement target product(s) from the terminal 201 of a user of an order-placing company (company A).

(S201) In S201, the first server 205 starts an auction (reception of order-accepting requests) related to the sent order of the above-described company A.

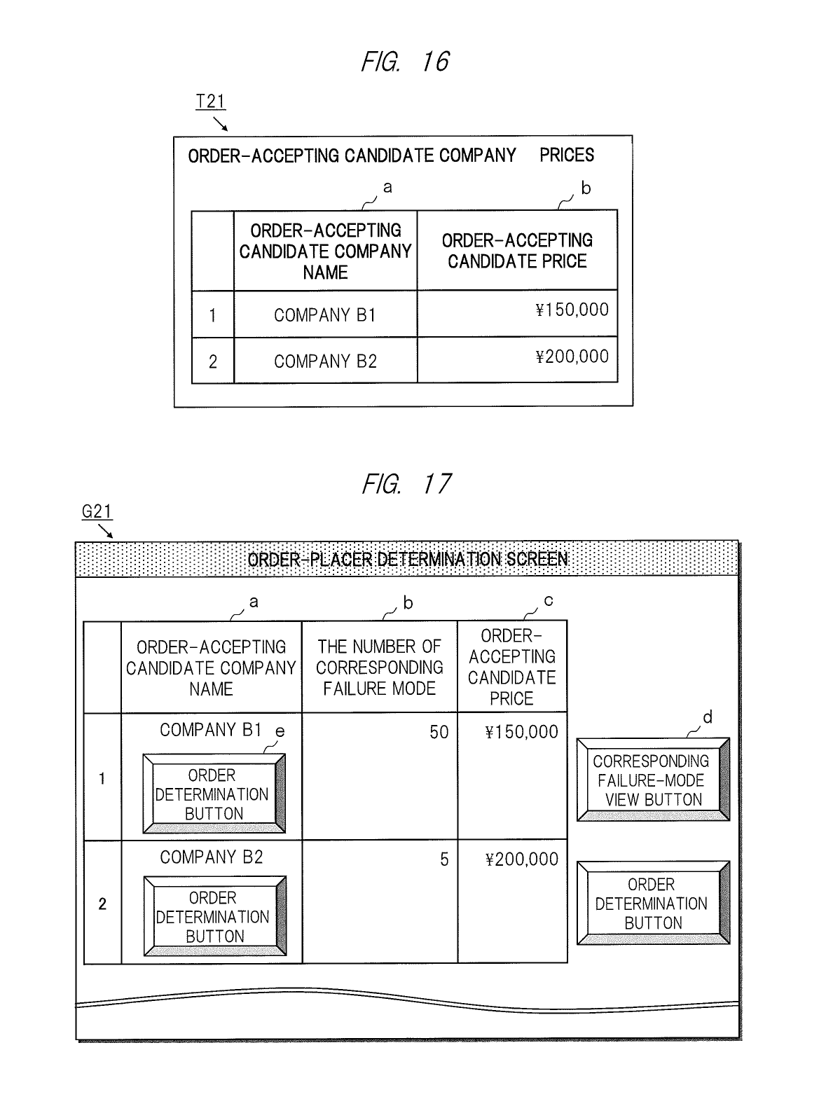

(S202) In S202, as the information of, for example, the order-accepting requests, the information (D1) of a supplier QC process-chart like T1 of above-described FIG. 4 and the information like T21 of below-described FIG. 16 (information of order-accepting requesting companies and requested order-accepting prices) is received from order-accepting requesting companies (company B1 to company Bm) (for example, company B1) to the first server 205.

FIG. 16 illustrates the table T21 of the requested order-accepting prices according to the order-accepting requesting companies (supplier (company B)). As illustrated in the drawing, T21 stores information of, for example, (a) the names of order-accepting candidate companies and (b) the candidate order-accepting prices.

(S203) In S203, a matching processing similar to the flow of above-described FIG. 9 is carried out. Therefore, the processing is requested from the first server 205 to the second server 206 via the network 90, the matching processing is carried out by the matching calculating unit 262 of the second server 206, and a result of the matching processing is returned to the server 205 via the network 90.

(S204) In S204, the information related to order-accepting requests (auction) is presented from the server 205 to the user of the terminal 201 of the order-placing side (company A) by an order-placer determination screen (G21) as illustrated in FIG. 17 described below.

The order-placer determination screen (G21) of FIG. 17 illustrates the information of, for example, (a) the names of the order-accepting candidate companies, (b) the number of corresponding failure modes, (c) and the candidate order-accepting prices. The information of each (company B) of the order-accepting candidate companies of the plurality of candidates is shown. “a” and “c” are the information according to T21, and “b” is the information based on above-described D5.

The user of the order-placing company (company A) side can view/check, for example, the failure modes and failure causes of the order-accepting requests, respectively by, for example, pressing respective failure-mode viewing buttons of “d”. The server 205 shows, on a screen, the information such as the failure mode and failure cause of each order-accepting request in accordance with the above-described operation. The user can subject the information such as the number of corresponding failure modes of “b”, detailed information thereof and the prices of “c” to a comparison examination to select an order acceptor (supplier).

(S205) In S205, when the user in the order-placing company (company A) side presses an order-accepting button of “e” on the screen (G21), order acceptance (supplier) in the present auction is determined. Then, the present processing is terminated. By virtue of this, the orderer (company A) can procure (purchase) target parts from the order receiver (company B).

[Effects, Etc.]

As explained in the foregoing, according to the respective embodiments, the information that specifically and appropriately points out quality problems in the manufacturing processes of the supplier(s) can be provided from the buyer (or orderer) to the supplier(s) (or order-accepting candidate(s)). The supplier(s) can recognize the quality problems in the manufacturing processes by viewing the information on a screen, and measures such as reviewing of the manufacturing processes (specifically, modification of the QC process chart) can be easily taken. The buyer can also check the state of the supplier(s) by viewing the information on the screen. By virtue of this, the manufacturing processes of the supplier(s) can be improved, and prevention of problem occurrence, quality improvement of procurement products, etc. can be achieved. Furthermore, in the second embodiment, procurement (order-placement) can be discussed by comparing the above-described information about the options (order-accepting candidates) of the plurality of suppliers on the screen.

Hereinabove, the invention accomplished by the present inventor has been explained in detail based on the embodiments. However, the present invention is not limited to the above-described embodiments, and it goes without saying that various modifications can be made without departing from the gist thereof.

In the above-described first embodiment, in relation to the matching processing, association of the process information of the buyer (A) and the supplier (B) has been carried out by the searching/matching of words. However, as a modification example, when the process information, etc. of both of them (A, B) is commonly controlled in advance by unique identifiers or the like, similar association may be carried out by the identifiers.

In relation to the matching processing, the information is not limited to the above-described information (D1) of the QC process chart, and the information of manufacturing processes including the information of elements that affect quality of procurement products such as processes, machines, humans, and materials can be used. Similarly, the information is not limited to the above-described information (D2) of the process FMEA (method of process FMEA), and quality related information including the information that, for example, what kind of problems and how much effects are caused by the elements can be used. Also, the information is not limited to the above-described information (D5) of the failure modes and failure causes, and the information of quality problems and effect analysis corresponding to a method applied instead of the method of the process FMEA can be used. In the above description, not only a process but also a predetermined element can be associated with a key.

### INDUSTRIAL APPLICABILITY

The present invention can be utilized in production control system, electronic commerce systems of electronic parts procurement, etc.

1 . . . PROCUREMENT QUALITY IMPROVING SYSTEM, 10 . . . TERMINAL (OPERATOR INPUT/OUTPUT DEVICE), 11 . . . CALCULATING DEVICE, 12 . . . DATA STORAGE DEVICE, 21 . . . SERVER, 22 . . . STORAGE, 90 . . . NETWORK, 111 . . . MATCHING CALCULATING UNIT (CALCULATING UNIT FOR ASSOCIATING SUPPLIER QC PROCESS-CHART INFORMATION WITH PROCESS FMEA INFORMATION), 112 . . . FIRST DISPLAY CALCULATING UNIT (CALCULATING UNIT FOR DISPLAYING SUPPLIER QC PROCESS-CHART INFORMATION, CORRESPONDING FAILURE-MODE/FAILURE-CAUSE INFORMATION), 113 . . . SECOND DISPLAY CALCULATING UNIT (CALCULATING UNIT FOR DISPLAYING SUPPLIER QC PROCESS-CHART INFORMATION), 201 . . . TERMINAL OF ORDERER, 202 . . . TERMINAL OF ORDER-ACCEPTING CANDIDATE, 205 . . . SERVER (ELECTRONIC-COMMERCIAL-TRANSACTION CONTROL DEVICE), 206 . . . SERVER (PROCUREMENT-QUALITY CONTROL DEVICE), 211 . . . ORDER-PLACEMENT INFORMATION STORAGE UNIT, 221 . . . QC PROCESS-CHART/COST INFORMATION STORAGE UNIT, 251 . . . SERVICE PROCESSING UNIT, 261 . . . PROCESS FMEA INFORMATION STORAGE UNIT, 262 . . . MATCHING CALCULATING UNIT (CALCULATING UNIT FOR ASSOCIATING ORDER-ACCEPTING-CANDIDATE QC PROCESS-CHART INFORMATION WITH PROCESS FMEA INFORMATION), 263 . . . DISPLAY CALCULATING UNIT (CALCULATING UNIT FOR DISPLAYING CORRESPONDING FAILURE MODES, FAILURE CAUSES, AND COST), D1 . . . SUPPLIER QC PROCESS-CHART INFORMATION, D2 . . . PROCESS FMEA INFORMATION, D3 . . . THESAURUS INFORMATION, D4 . . . SUPPLIER QUALITY-LEVEL INFORMATION, D5 . . . CORRESPONDING FAILURE-MODE/FAILURE-CAUSE INFORMATION, D6 . . . SUPPLIER QC PROCESS-CHART REVISED INFORMATION, D7 . . . REVIEW RESULT INFORMATION.

1. A procurement quality improving system that carries out information processing related to improvement or control of quality of a procurement product, the procurement quality improving system comprising:
a calculating device having a processing function of computing a problem in a manufacturing process of a supplier; and
a data storage device for storing data information to be used by the calculating device,
wherein the data storage device stores first information including information related to the manufacturing process of the supplier and second information including quality-related information related to the manufacturing process of the supplier, and
the calculating device includes:
a matching calculating unit for carrying out a processing of association of the first information with the second information of the supplier; and
a first display calculating unit for carrying out a processing of presenting information including the first information and information of a quality problem computed according to the association to the supplier.

2. The procurement quality improving system according to claim 1,
wherein the data storage device stores information of a QC process chart of the supplier as the first information;
the matching calculating unit carries out the association using information of a process element included in the information of the QC process chart of the supplier of the first information; and
the first display calculating unit carries out a processing of presenting, to the supplier, information of a key-point process related to the quality problem in the manufacturing process of the supplier, the information of the process computed according to the association.

3. The procurement quality improving system according to claim 1,
wherein the data storage device stores information of process FMEA as the second information;
the matching calculating unit carries out the association using information of the process included in the information of the process FMEA of the second information; and
the first display calculating unit carries out a processing of presenting, to the supplier, information including the first information and information of a corresponding failure mode and a failure cause computed by the association.

4. The procurement quality improving system according to claim 1,
wherein the calculating device has a second display calculating unit carrying out:
a processing of accepting a revise for the first information from the supplier through the first display calculating unit and presenting the revised first information to the supplier or a buyer; and
a processing of presenting, to the supplier or the buyer, status information of a confirmation by the supplier with respect to the information presented to the supplier.

5. The procurement quality improving system according to claim 1,
wherein the matching calculating unit carries out an exact search processing using process element information included in the first information and process information included in the second information, and mutually associates corresponding information obtained as a result of the search processing.

6. The procurement quality improving system according to claim 1, wherein
the data storage unit stores supplier quality-level information describing a quality level of the supplier; and
the matching calculating unit carries out the association in accordance with the supplier quality-level information in addition to the first information and the second information.

7. The procurement quality improving system according to claim 1, wherein
the matching calculating unit carries out the association by:
a search processing using a similar word according to thesaurus information related to the process in addition to the first information and the second information,
a search processing using morphological analysis and cluster analysis of a text mining method, or
a search processing using an order relation of a plurality of steps of the manufacturing process.

8. A procurement quality improving system used in an electronic commerce of procurement and carrying out information processing related to improvement or control of quality of a procurement product,
wherein a first terminal of a buyer or an orderer, a second terminal of a supplier or an order-accepting candidate, a first server that controls the electronic commerce of the procurement, and a second server having a processing function of calculating a problem of a manufacturing process of the supplier are connected to a network;
a storage connected to the second server or the network stores first information including information related to the manufacturing process of the supplier and second information including quality related information related to the manufacturing process of the supplier;
the first server receives access from the first and second terminals and provides a service related to order placement and order acceptance of the procurement by being linked with the second server; and
the second server includes:
a matching calculating unit that carries out a processing of association of the first information with the second information of the supplier; and
a display calculating unit that carries out a processing of presenting, to the first or second terminal, information including the first information, information of a quality problem computed by the association, and cost information related to the order placement and order acceptance.

9. The procurement quality improving system according to claim 8,
wherein, in the electronic commerce of the procurement,
in the service, the first server receives information of a requested order-accepting price from each of the second terminal serving as the order-accepting candidate and presents, to the first terminal serving as the orderer, information including the information of the requested order-accepting price according to the second terminal each serving as the order-accepting candidate and the information of the quality problem, and
the first terminal serving as the orderer can execute determination of order placement to the order-accepting candidate based on the presented information, the determination being executable with respect to the first server.

10. The procurement quality improving system according to claim 8,
wherein information of a QC process chart of the supplier is stored as the first information;
the matching calculating unit carries out the association using information of a process element included in the information of the QC process chart of the supplier of the first information; and
the display calculating unit carries out a processing of presenting, to the second terminal of the supplier, information of a process serving as a point related to the quality problem in the manufacturing process of the supplier, the information of the process computed according to the association.

11. The procurement quality improving system according to claim 8,
wherein information of process FMEA is stored as the second information;
the matching calculating unit carries out the association by using information of a process included in the information of the process FMEA of the second information; and
the display calculating unit carries out a processing of presenting, to the second terminal of the supplier, information including the first information and information of a corresponding failure mode and a failure cause computed according to the association.
